(19) United States
(12) Patent Application Publication
(10) Pub. No.: US 2014/0013249 A1
(43) Pub. Date: Jan. 9, 2014

(54) CONVERSATION MANAGEMENT SYSTEMS AND METHODS

(71) Applicants: Shahram Moeinifar, Oakville (CA); Ali Ghafour, Ajax (CA)

(72) Inventors: Shahram Moeinifar, Oakville (CA); Ali Ghafour, Ajax (CA)

(21) Appl. No.: 13/935,139

(22) Filed: Jul. 3, 2013

Related U.S. Application Data
(60) Provisional application No. 61/668,817, filed on Jul. 6, 2012.

(51) Int. Cl. H04L 12/58

(52) U.S. Cl. CPC H04L 51/00
USPC 715/758

(57) ABSTRACT

A conversation management system is configured to provide a conversation user interface to a third party content provider. The third party content provider could present the conversation user interface to its users on a platform of its choosing while controlling aspects of the conversation user interface through a conversation management platform provided by the system. The conversation user interface could then be used by the third party content provider to enable a full spectrum of conversation functionality within the content provider's existing infrastructure.

This non-utility application claims priority to provisional application Ser. No. 61/668,817, filed Jul. 6, 2012. This and all other documents cited herein are incorporated by reference in their entirety.

### FIELD OF THE INVENTION

The field of the invention is network communication log management technologies.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

On-line publishing platforms (e.g., news aggregators, goods providers, social networks) typically have highly restrictive platforms through which users can interact. For example, the website cnn.com allows users to post a comment on related articles, but fails to provide users the ability to create their own topics of conversation unattached to a published article. Users of such websites that wish to discuss a new topic of relevance must leave the site for other sites or communities that have such features. Thus, cnn.com looses a captive audience despite having such a large user base. Ideally, such on-line websites should allow user to remain on the site and to engage in a multifaceted conversation on nearly any topic beyond topics attached to a published article.

To some extent others have put forth effort toward conversation technologies, but have failed to provide a conversation management infrastructure that can be leveraged by third party content providers. For example, U.S. patent application publication 2007/0038777 to Low et al. titled “Conversation Message Server”, filed Jun. 16, 2006, describes a message server that manages addresses of conversation participants. Another example includes U.S. patent application publication 2005/0188022 to Hanson et al. titled “Method and Apparatus to Provide a Human-Usable Interface to Conversational Support”, filed Jan. 2, 2004, which describes a framework that allows users to interact with conversation-enabled applications. Yet another example includes U.S. patent application U.S. patent 2006/0190537 to Morris titled “Method and System for Enabling Structured Real-Time Conversations Between Multiple Participants”, filed Feb. 23, 2005. Morris makes further progress by allowing users to select an available structured chat conversation and by passing control to a conversation application.

Although the cited references are applicable to their specific uses, all of the references fail to provide insight allowing third party content providers to leverage a conversation management infrastructure that allows the provider's users to create their own topics of conversation.

Thus, there is still a need for improved conversation management systems.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Electronic elements that are “functionally coupled” with one another are linked in such a way so as to transmit electronic power or data from one functionally coupled device to another functionally coupled device, such as through wired or wireless technologies.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems and methods in which a conversation management system provides a conversation management platform for third party content providers (e.g., shopping sites, news sites, web servers). Such a conversation management platform allows the third party content provider to present a conversation user interface where users of the content provider could create topics of conversation within a third party content provider's platform, such as a website, encouraging users to remain within the environment of the content provider's platform when communicating with other users.

The conversation management system typically has a conversation server that communicates with the third party content provider using a server interface. Contemplated server interfaces include a software-as-a-service interface, an application program interface, a web server, and an HTTP server. Through this server interface, the third party content provider could then request the conversation server to provide a conversation user interface for use within a platform controlled by the third party content provider and/or accessible by its users.

The server could instantiate a conversation management platform associated with the content provider, where the management platform has a plurality of management rules defining the management functionality of the conversation management platform. Such rules could include authorization rules, authentication rules, filter rules, topic rules, thread rules, permission rules, user interface rules, curation rules, and metric aggregate rules. Specifically, the third party content provider could dictate what users are authorized to post to selected conversation user interfaces, what users are authorized to have administrative access to a conversation user interface, how a user is authenticated with the conversation user interface, what types of filters could be applied to portions of a conversation user interface, what types of topics could be posted to a conversation user interface, how many threads and sub-threads are allowed in a conversation user interface, and ways portions of a conversation could be aggregated and/or curated, for example. Instantiation of the conversation management platform is typically performed in response to command stimuli, for example a request by the third party content provider for a conversation management platform, or payment of a fee by the third party content provider.

A plurality of contemplated fee structures are contemplated. For example, a content provider could choose from a plurality of subscription fee offerings, where the content provider pays a set fee for a set number of conversation management platforms over a set period of time. Alternatively, a content provider could pay a set fee for every conversation user interface presented, or for every conversation management platform requested. In another embodiment, a content provider could pay a set fee for an exclusivity license to a conversation user interface. This is particularly useful for content providers that want a particular conversation user interface, or set of conversation user interfaces, to represent a part of that content provider's brand image. In such a scenario, when the exclusive license is granted to the content provider, the conversation server would remove that conversation user interface (or set of conversation user interfaces) from the pool of conversation user interfaces available to other third party content providers. In a preferred embodiment, the content provider could request a customized conversation user interface that is offered as part of an exclusive license package. For special conversation user interfaces with functional and/or ornamental features beyond those features offered by other conversation user interfaces, an auction could be held where the winning bid comprises the fee paid. In other embodiments, instead of providing a fee, the content provider could agree to display one or more advertisements in its environment platform. Such an advertisement could be displayed as part of the user interface or elsewhere on the content provider's platform.

The conversation management platform could be configured to reside upon the conversation server, a system owned or otherwise controlled by the third party content provider, intermediary server functionally connected to the conversation server and the third party content provider, a server remote from the third party content provider, or some combination of the above. In some embodiments, the conversation user interface could be provided on a mobile device such as a cell phone, tablet, or an automobile. In either case, the server is typically configured to enable the third party content provider to present or host the conversation user interface—typically to an environment of the third party content provider accessible to the provider's users. The conversation management platform could also be configured to update the conversation user interface based upon conversation content obtained through the conversation user interface. Control of the conversation user interface by the third party content provider is typically performed through the conversation management platform in accordance with the management rules. In some embodiments, the conversation user interface could comprise a social network interface that functions as a portal to a social media content provider.

The conversation user interface could be configured to handle one or more types of conversation content, for example multi-modal content having text data, audio data, kinesthetic data, video data, metadata, and/or image data. Where the conversation user interface resides on a mobile device, conversation content could be input by the user, such as through a mobile keyboard or through a speech-recognition module, or could be gathered automatically by a program on the mobile device, such as GPS location information or IP address data. As users interact via the conversation user interface, the conversation server could use the conversation management platform to update the user interface in response to conversation content obtained via the user interface. The conversation management platform could also be configured to analyze the conversation content and indicate a topic or a thread via the conversation user interface based upon its analysis. While conversation content is typically provided by the third party content provider or by users of the third party content provider's platform environment, some of the conversation content could be obtained from other sources, such as other content providers that provide similar content, users of other systems commenting on similar content, or advertisers that provide advertisements associated with the content.

In another embodiment, a conversation server could be configured to provide a plurality of conversation platforms, and a plurality of types of conversation platforms, where each platform could be associated with a multiple third party content providers or a distinct third party content provider. Where each platform is associated with multiple third party content providers, the platform could accept comments from users from different third party content providers looking at similar content. However, a single platform might be configured to provide user interfaces with distinct ornamental features to distinct content providers, such that each content provider's user interface looks different from one another, but enables users of the different content provider environment platforms to communicate with one another.

Where each platform is associated with a distinct third party content provider, the conversation server could construct an inter-platform communication channel among some of the plurality of conversation platforms through which the platforms could exchange conversation content with one another. In such an embodiment, the conversation server could provide a list of communication channels where an administrator could select one or more channels for a conversation management platform to be attached to. All conversation management platforms attached to a channel could then be configured to exchange conversation content with one another. For example, a plurality of content providers that provide information on a sports game could select a channel for a specific game (i.e. Lakers v. Clippers game 3), show distinct content to each of their users regarding that game, have distinct conversation user interfaces, but all join the same channel to allow all users discussing that specific game to communicate with one another.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an exemplary conversation management system.

FIG. 2 is a schematic of another exemplary conversation management system

FIG. 3 is an exemplary conversation interface that allows a user to create a topic.

FIG. 4 is an exemplary administrator user interface for the conversation interface of FIG. 3.

FIG. 5 is an exemplary landing page for a topic that aggregates the conversation about a topic as a live feed.

FIG. 6 shows the exemplary landing page of FIG. 5 having an auto-suggest interface for topics.

### DETAILED DESCRIPTION

It should be noted that while the following description is drawn to a computer/server based conversation management systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating conversation management signals that configure remote content providers to present conversation interfaces to users.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” over a network where two or more network devices are able to exchange data, possibly via one or more intermediary devices.

The disclosed inventive subject matter represents technology that allows users on a content provider's platform (e.g., cnn.com, thestar.com, amazon.com) to create topics of conversation associated with content. Users of the content provider's platform, could follow published content or engage with other users of the content provider's platform via a conversation user interface accessible through the content provider's platform. The disclosed approach could give rise to a conversation management platform that allows third party content providers or publishers (i.e., clients accessing the content provider's platform) to operate one or more conversation forums within the platform retaining their audience of users. Such accessibility and visibility allows users to create topics of conversations, follow the conversations, and remain engaged on the client sites. Thus, the third party content provider is able to generate further revenue, possibly from advertisers, because end user's remain engaged.

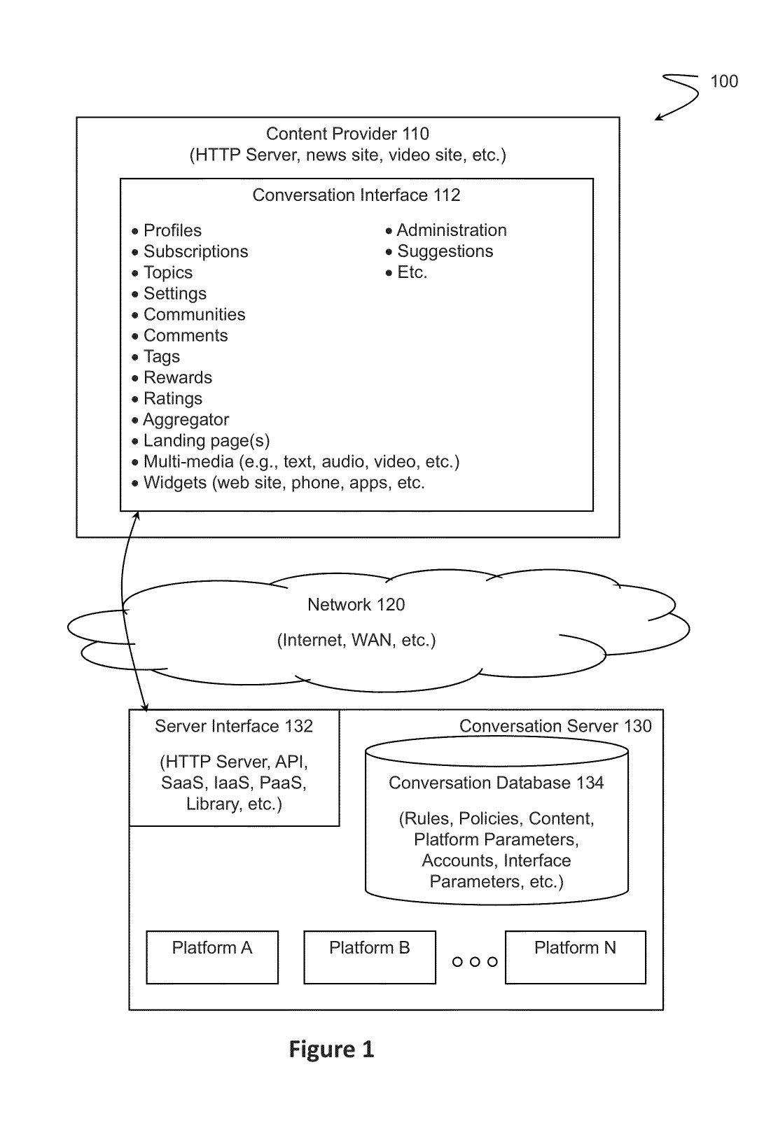

FIG. 1 shows an exemplary conversation management ecosystem 100 having a conversation server 130 that offers one or more conversation management capabilities to a content provider 110. Contemplated content providers include goods/services content providers, news aggregators, review content providers, and social networks. Content provider 110 is shown here as being functionally coupled with conversation server 130 via a server interface 132 through network 120. Server interface 132 could be any appropriate interface that allows a computer system to provide modular content to a remote content provider through a network system, such as a software-as-a-service interface or an application program interface (API), a web server (e.g., SOAP, WSDL, XML, RPC, etc.).

Content provider 110 could interact with conversation server 130 in various ways. In some embodiments, content provider 110 could send a request to conversation server 130 for a conversation interface that could be positioned or otherwise presented possibly as a “comments” section associated with the provider's content. In other embodiments, conversation server 130 could push conversation interface 112 to an environment platform of content provider 110, such as a web page. Regardless of how content provider 110 and conversation server 130 interact, it is preferred that conversation server 130 offer its services in exchange for a fee (e.g., a subscription fee, advertising fee, per use payments, per instantiation fee, a topic charge, an exclusivity charge, a bid, other types of payment).

Database system 212 preferably has a non-transient memory that holds data used by the conversation management system to instantiate and administer conversation management platforms that control various conversation interfaces provided to third party content providers. For example, database system 212 could store one or more management rule templates used by the conversation management system to set up default values for management rules for each conversation management platform.

Conversation server 130 has a conversation server database 134 saved on a non-transient memory that saves data used by the conversation management system to instantiate and administer conversation management platforms that control various conversation interfaces provided to third party content providers. For example, database 134 could store one or more management rule templates used by the conversation management system to set up default values for management rules for each conversation management platform, saved policies comprising rules for each instantiated conversation management platform, conversation content entered in by users and/or administrators to conversation user interfaces presented by each conversation management platform, platform parameters, account information for each user that accesses the conversation user interfaces, and interface parameters used to properly present each conversation user interface within the environment of the third party content provider.

Each content management platform is shown as operating as a virtual machine within the conversation server itself, but could possibly be instantiated upon content provider 110. When a conversation platform is installed on a content provider system, the platform preferably remains under control of the conversation server. In a preferred system, redundant portions of a content management platform are instantiated on a plurality of computer systems (conversation server 130, content provider 110, and other computer systems within network 120) to form a “cloud” service that functions to provide conversation interface 112 to content provider 110 when certain computer systems go offline. The conversation management platform could also be instantiated on an intermediary server a cloud system for example.

Third party content provider 110 could embed conversation interface 112 within one of its environment platforms, or could create a new content environment having conversation interface 112. Such a conversation interface could be, for example, a comments section that allows a plurality of users to post to a single conversation thread, a forum that allows users to post comments that specifically target one or more users of content provider 110, or a message broadcaster that allows users to post comments that target one or more conversation threads. In response to content provider 110's request for a conversation user interface, conversation server 130 could instantiate management platform A, which then constructs conversation interface 112 provided to content provider 110. Conversation management platform A could manage one or more conversation user interfaces where any conversation could span across one or more third party content servers.

Conversation server 130 could be configured to instantiate one or more conversation management platforms A, B . . . to N through which conversation server 130 controls or otherwise manages conversations occurring on the content provider. Each conversation management platform A, B . . . to N could be associated with a different third party content provider. In some embodiments, each of the conversation management platforms could exchange conversation content with each other via an inter-platform communication channel. Such an approach could allow end users to discuss a topic and share conversation content via their respective conversation interfaces on each content provider. Without such a system, each user would need to leave the content provider's environment platform, to congregate on a common conversation platform in order to communicate with one another.

Content provider 110 preferably has administrative control over conversation interfaces presented through a requested conversation management platform. The conversation management platform could enable the content provider to offer stronger “forum-like” characteristics within the comments sections of content that they present. The content provider could also set forth one or more content provider rules that ensure that human employees or computer agents oversee and monitor conversation content posted within the conversation interface. The conversation interface could also be leveraged as valuable content for generating or retaining advertising revenues.

Conversation server 130 could also enable content provider 110 to present a conversation user interface 112 to end users through a customized portal for that end user. In the example shown, the conversation interface is presented as a comment section on the content provider's environment platform. One should appreciate the conversation interface could be configured to present a full or partial conversation interface on any viewing device. For example, conversation interface 112 could be constructed or adapted to be rendered on a web browser, a tablet, a cell phone, an appliance, a set top box, a kiosk, or other end user device.

In other embodiments, a conversation management platform could be configured to construct a conversation interface in a manner that is suitable for use with a mobile device. Contemplated mobile devices could include a smart phone, cell phone, a table computer, a game device, or even a vehicle (e.g., automobile, airplane, train). In such embodiments, the mobile device conversation interface could present an optimized conversation interface that only provides a portion of the conversation interface features to save on screen real estate.

An exemplary mobile device conversation interface could also be configured to acquire one or more modalities of conversation content. Consider a cell phone for example. The conversation interface rendered on the cell phone could request sensor data from the cell phone's camera, microphone, screen, keyboard, or other interfaces. Exemplary sensor data includes text entered via a mobile keyboard, words uttered into a word recognition software, or photographs taken by the mobile device, a location of the user, or a digital signature saved on the mobile device. The captured conversation content could then be send via the conversation interface to the conversation management platform. The conversation server, via the conversation management platform, could update other relevant conversation user interfaces. Thus the conversation content could originate from nearly any source including sources other than the content provider's site.

Conversation content could also include multi-modal data. Exemplary data modalities include text data, audio data, kinesthetic data (e.g., vibration, texture), video data, image data, metadata (e.g., tags, rankings, votes, likes, ratings, metrics), or other types of modalities. Thus, the conversation content could extend beyond mere use of text into a full, rich spectrum of conversation interactions. An especially preferred type of conversation content could include advertisements provided based on the content within conversation content. As the conversation content flows through the conversation management platform, the platform could monitor elements within the content (e.g., topics, keywords, phrases, normalized concepts, tags, etc.). The platform could use the elements to obtain advertisements. The advertisements could be obtained from an advertisement server, the conversation server, or other sources. The advertisements could be interlineated with the conversation content flow or presented as a separate stream.

One should appreciate that a conversation management platform could have many roles or responsibilities with respect to managing conversation content or the flow of a conversation. The platform could indicate that a topic is present via the interface, possibly based on the conversation content. Topic management could comprise one or more of the following functionalities: allowing a user to manage topics, automatic topic identification, deleting a topic, advertising based on topic, monitoring topic lifecycle, or other type of management function. Still further, the conversation management platform could also indicate that a thread of conversation is present via the conversation interface. As users submit conversation content, the content could be bound together in a coherent fashion to indicate a flow, possibly associated with one or more topics. Such an approach could allow users to easily identify which portions of the conversation content are relevant to each other. In addition, users could observe the flow in an orderly fashion as opposed to a linear flow in typical forums. Advertising could also be highly targeted to aspects of the conversation by topic, by poster, by concept, by thread, or other feature of the conversation.

The conversation management platform could also take on many different forms. In some embodiments, the conversation management platform operates across multiple environments of one or more content providers, such as an HTTP website, HTML5 website, a flash portal, a mobile application, a client-side scripting application, or an AJAX script. Preferably, the platform maintains persistence of a conversation in time so that one or more conversations could be reviewed, searched, or other utilized at a future date. In other embodiments, the conversation management platform could be transient in nature, possibly even instantiated for a limited time to serve a specific purpose. For example, the platform could be constructed for a small group of friends or associates during a social function. When the social function has ended, the platform could be deconstructed or be otherwise rendered unavailable to users of the platform. Still, the conversation(s) could be archived if desired.

Preferred management platforms comprise management rules that govern operating on the management platform with respect conversation content. The management rules could be established based on one or more templates having a basic set of rules. For example, the basic rules could include removal or filtering of offensive content. The management rules could also include customized rules obtained from the third party content provider. For example, the content provider could start with a basic rule template and expand on the rules by adding exclusion of references to competitors or other topics. Still further, more complex management rules could include govern exchange of conversation content among conversation interfaces at multiple third party content provides. Such an approach is considered advantageous to ensure interesting content could be available to a user while the user remains at the third party content provider's site. Additional management rules could include rules for authorizing use or content, authenticating users, filtering, managing topics, managing threads, granting permissions, managing the user interface, curating conversation content, aggregating use metrics or other metrics, or other types of rules.

The conversation management system could be, by its nature, a social ecosystem. Especially preferred systems integrate social networking interfaces with the conversation user interface. For example, the conversation content could be obtained from social network (e.g., Facebook®, Twitter®, Yammer®, etc.) or could be injected into social networks. Still further, the conversation interface could be instrumented with “like”, “vote”, “thumbs up/down”, “ranking”, or other features for social networks.

Additional capabilities that could be included within the conversation management system could comprise the following:
Allow users to create topics by pre-pending a topic with a hashtag (e.g., #) within the commenting tool in the conversation interface;
When a user starts entering a hashtag, the system will suggest topics that are most popular within that thread and the system as a whole. The suggestions could originate from the current conversation, from conversation within the third party content provider site (or portfolio of sites), or even from across multiple third party sites;
Allow administrators to create/edit and delete topics in the commenting tool or via an administrator section of the conversation management platform. The admin section could also show the trending topics, threads, users, or other aspects of the conversation;
Create one or more active landing pages (e.g., javascript, etc.) that shows the topic from all areas of the site, bringing together all mentions of a topic into one screen;
Allow for presentation of the conversation content as a live feed with an ability to pause the feed. Such an interface page within the conversation interface could also include a search box to search for other topics, threads, users, or other content;
Allow a user to follow a topic or receive emails when new conversations appear related to a topic. Such a “following” preference could be set by a user via a user interface;
Allow a user to share a topic with other social networks;
Allow a user to chat about an topic on a landing page;
Create a widget which displays the most trending topics in a conversation, on the third party site, or across the entire system. Further, topics could be promoted by site administrators, or could include default topics;
Display trending topics via a widget within the conversation interface for one or more comment streams;
Allow site administrators to turn the conversation management system on/off via a setting in the administrators area;
Allow a user to create a topic from outside the commenting widget (i.e. the display widget); or
Allow the creator of a topic to enter a description for the topic, which could be displayed in a landing page.

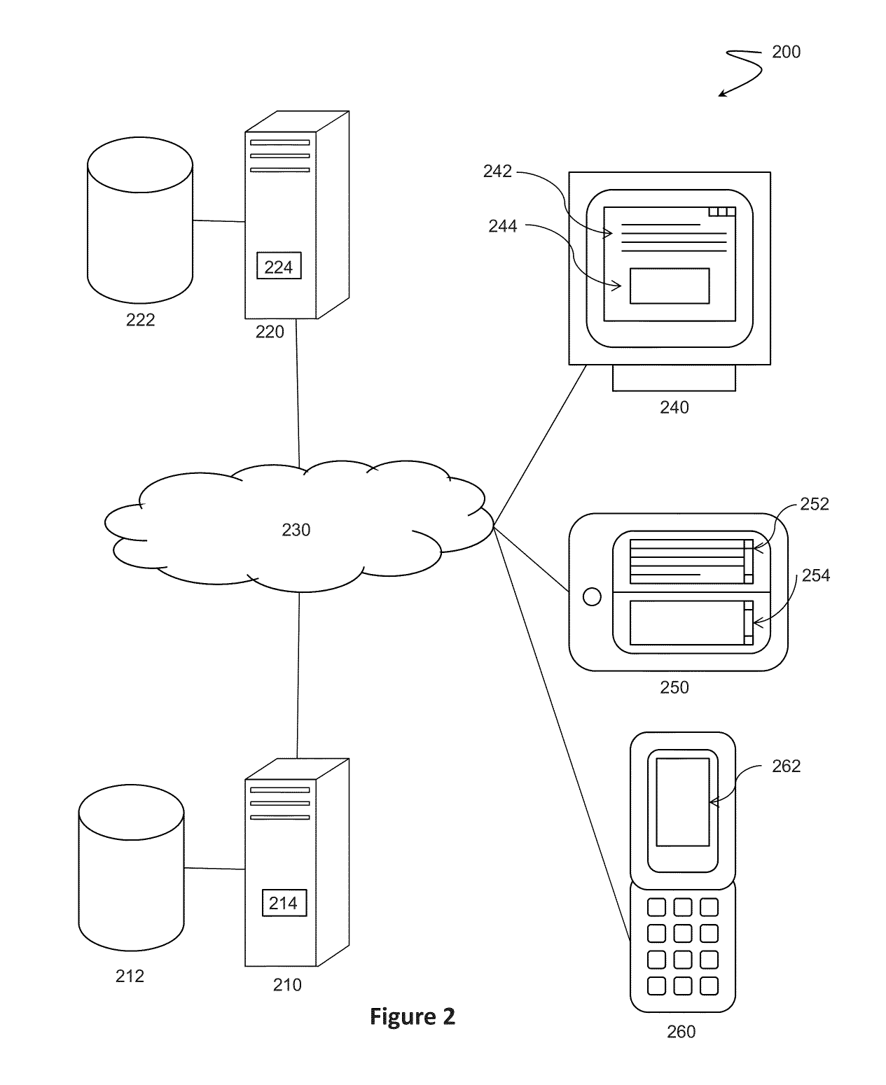

FIG. 2 is a schematic of another exemplary conversation management system 200, comprising a conversation computer system 210, a content provider computer system 220, a network 230, and client devices 240, 250, and 260.

Conversation computer system 210 is shown as a computer server 210 having a processor, transient memory, and non-transient memory, and code saved to a non-transient memory that is configured to coupled to enable interactions between computer server 210 and devices functionally coupled to the server. The computer code that controls the conversation management system could be a single software saved on computer server 210, or could be a distributed software that has portions saved on computer server 210, and portions saved on other computer systems, such as a distributed environment on network 230 or on content provider computer system 220. Conversation computer system is 210 is functionally coupled to network 230 and to database system 212 through suitable wired or wireless connectors that allow data transfer and commands to be routed to and from network 230 and database system 212, respectively. While conversation computer system 210 is shown euphemistically as a single computer server, conversation computer system 210 could comprise any number of computers that functionally work together to instantiate and maintain conversation management platforms.

Database system 212 preferably has a non-transient memory that holds data used by the conversation management system to instantiate and administer conversation management platforms that control various conversation interfaces provided to third party content providers. Database system 212 is shown as a single storage facility, but could comprise a plurality of storage facilities having non-transient memories, and could even comprise a plurality of interconnected computer systems.

Content provider computer system 220 and content provider database system 222 could be similarly configured to be one or more computer systems coupled to a database system storing information used by the content provider computer system to present content to its users. Content provider computer system 220 typically sends a request to conversation computer system 210 for a conversation user interface to be used on its system. Conversation computer system 210 may immediately instantiate conversation management platform 214 keyed towards the needs of content provider computer system 220, but preferably first waits for confirmation of a payment from the third content provider before instantiating the conversation management platform.

Once conversation management platform 214 is instantiated, third party computer system 220 could implement one or more conversation user interfaces associated with its published content 224. In some embodiments, third party content provider presents its content in different ways to different users, and also would like a different conversation user interface to be displayed for such users. For example, computer monitor 240 typically shows content through a web browser having modifiable dimensions, showing content 242, where a conversation user interface 244 can easily be placed adjacent or underneath the presented content. However, computer tablet 250 may show content through a static web browser that must be magnified and scrolled through in order to view, having scrollable content 252 in an upper half of the browser and a scrollable conversation user interface 254 in a tower half of the browser. Mobile phone 260 may show content through a smaller web browser that is optimized for a smaller screen, which may have one mode (not shown) to show the presented content and another mode to show conversation user interface 262, both of which would take up the entirety of the screen of mobile phone 260. Preferably, conversation management platform 214 aggregates conversation data input by each of the users of the different user interfaces to a single conversation, allowing users on a plurality of platforms to communicate with one another without leaving the content provider's environment platform.

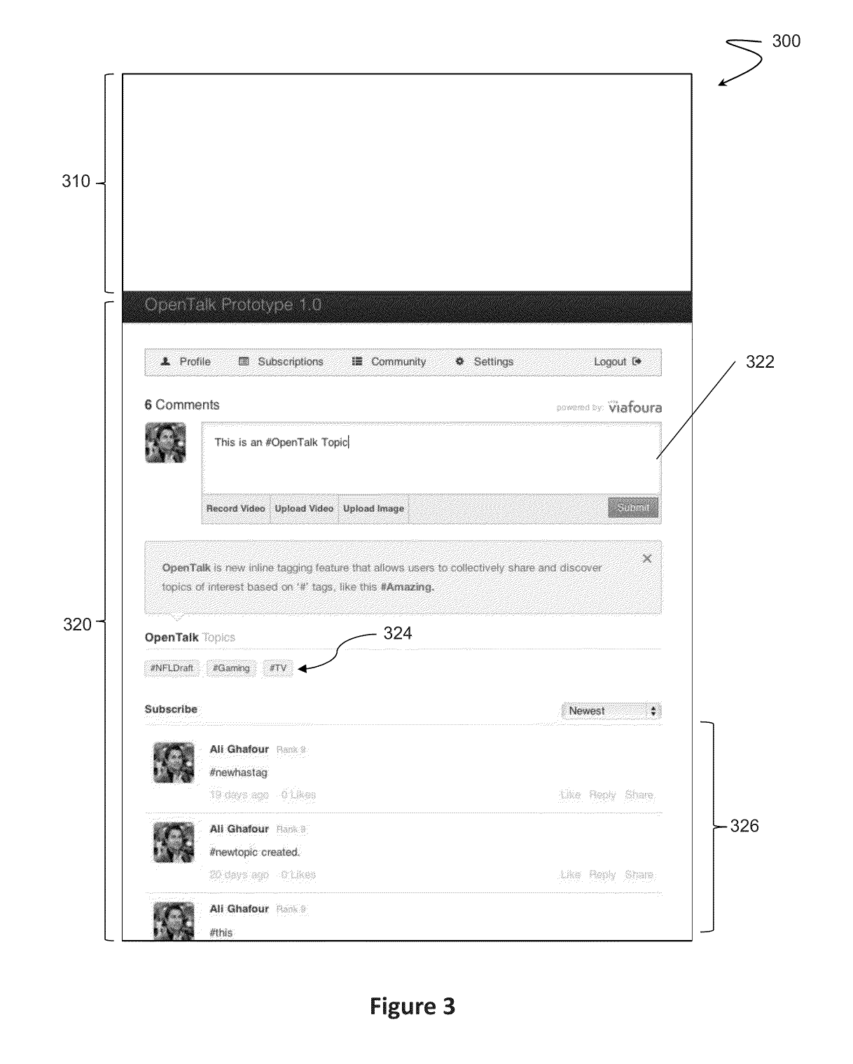

FIG. 3 shows an exemplary third party content environment 300 with an integrated conversation user interface having a content section 310 and a conversation user interface 320. A user could contribute to a conversation by posting content to comment box 322, such as text, photo(s), video(s), or a combination thereof. A user could also select only a subset of audience members that can read that comment, either by specifying the users, or by selecting an indicator for a group of users (i.e. members of a forum or members that have a designated user badge). A user could also designate a topic of conversation within a conversation thread by pre-pending a topic name with a topic identifier—in this case the topic identifier is a hash tag (the # sign). The corresponding thread 326 could reside underneath associated content section 310 provided by the third party content provider, allowing a user to see previous conversation threads. In some embodiments, a user might only be able to select from a list of possible topics, while in other embodiments any user could create a topic of that user's choosing. Thus, the illustrated interface could appear as part of the third party content provider's site. Once a topic is created, other users could select the topic from a list of topics 324, allowing a user to filter comment messages to only include messages relevant to the poster's topic, or to select one or more topics to attach a comment to. In some embodiments, the user interface may only display the most popular topics, such as the top 5 topics in the conversation.

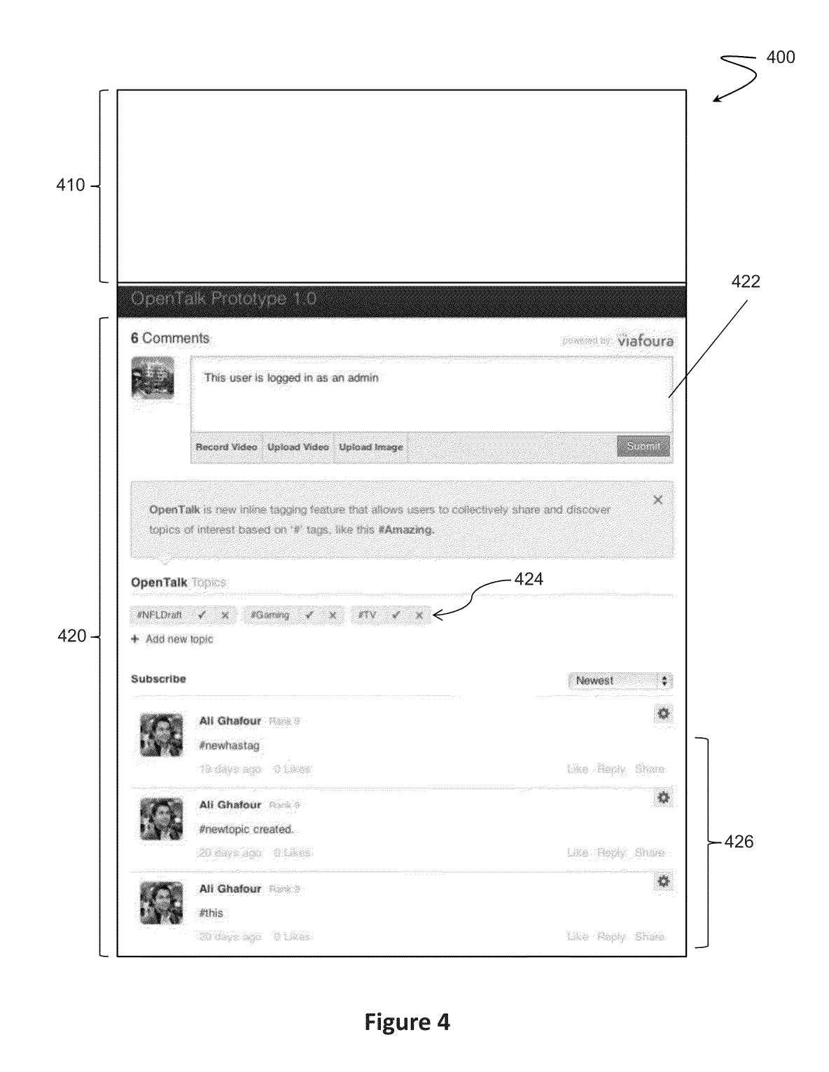

FIG. 4 illustrates a possible administrator interface 400 for the third party content environment shown in FIG. 3. Once an administrator is logged into the system, the administrator could be presented with one or more controls 424 over the corresponding conversation management platforms while monitoring conversation thread 426. For example, the administrator could approve, create, delete, or otherwise manage portions of a conversation by modifying the available topics or readable comments. In some embodiments, when an administrator deletes a topics, all of the topics attached to comments within the conversation are deleted by the system. In other embodiments, an administrator could merge topics together, such as when an administrator might want to merge the topics “NFL Draft,” “NFLDraft,” “National Football League Draft” and “Football Draft” into a single topic “NFL_Draft.” By allowing an administrator to rename topics, users of such a communication user interface could be trained to use a specific type of topic format over time. Here, the conversation input box 422 is locked with an indicator stating “This user is logged in as an admin” to prevent the administrator from joining in the conversation, but could be configured to allow an administrator to post comments of the administrator's own.

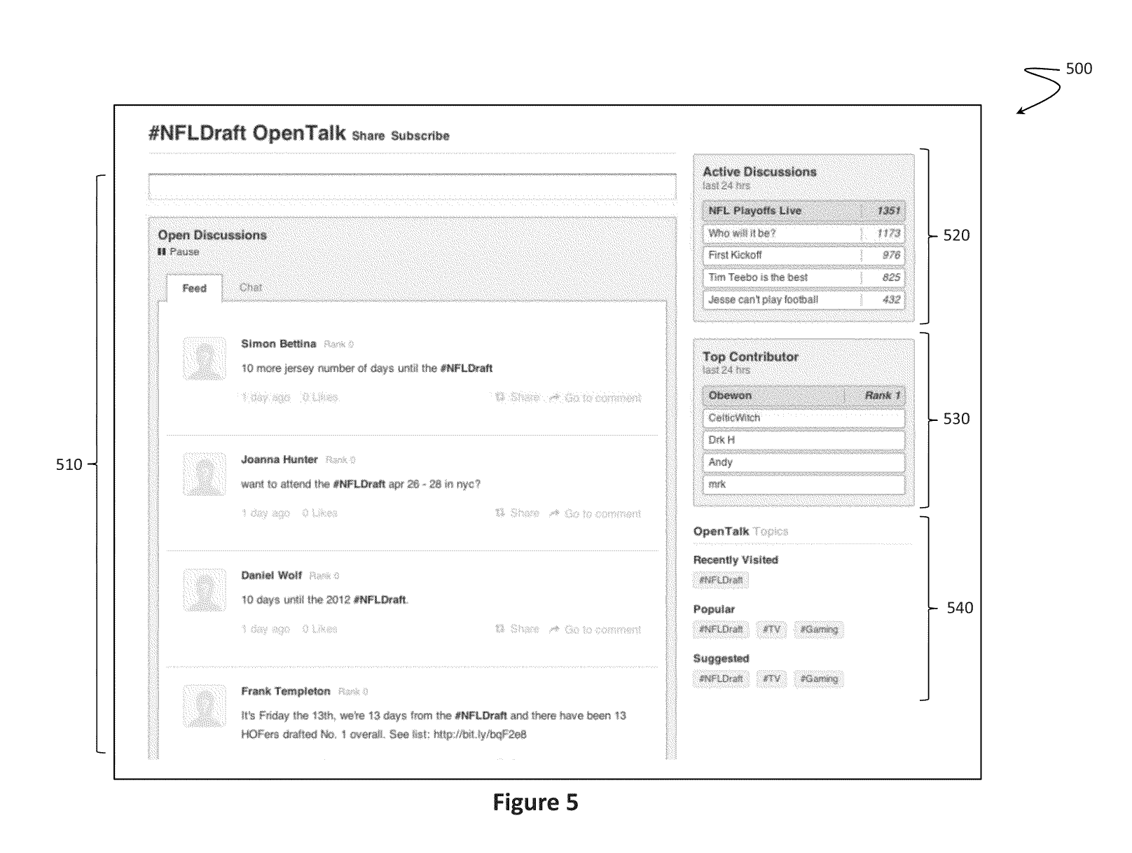

FIG. 5 shows a landing page 500 that operates as an aggregator for a topic; which in this case is #NFLDraft. Generally, a user navigates to such a landing page by clicking on one of the topics in a displayed list, such as the list of topics 324 in FIG. 3. Topic landing page 500 could present references to the topic and/or could be presented as conversation feed 510. Preferably, the conversation feed is presented in real-time, so when a user of one user interface inputs a comment, a user of another user interface reads the comment within a few seconds. One should note that the landing page preferably also operates within the environment platform of the third party content provider or could be via an external interface (e.g., cell phone interface, another cite, the conversation server, etc.). Note the interface could also provide for control over the feed via a “pause” control. All controls are contemplated including start, stop, fast forward, reverse, reorganize content, or other controls.

Conversation feed 510 shows a chat interface that allows users to engage in live chats regarding the topic as desired. One should further appreciate that this page, or other pages for that matter, could be shared via social networks. Therefore, users could subscribe to the feed and receive the content live, delayed, or via other social networking interfaces.

Widgets 520, 530, and 540 show possible applications within a conversation interface, which provide additional information, such as data on other topics, data on other users, and data on the current user, respectively. The third party content provider could decide which widgets would be relevant to their circumstances. In the example shown, the widgets expose statistics regarding topics previously created in the system. The top widget displays which topics have had the most topic activity in the last 24 hours, preferably allowing users to navigate to other popular topics by clicking on that topic. The middle widget displays which users are most active, (preferably allowing users to keep track of notable users and possibly visit that user's profile to glean additional information. The bottom widget illustrates various topic attributes: recently visited, popularity, and suggested topics that might be of interest to the user. The list of suggested topics might be generated by a system that analyzes each user's topic-visiting habits to generate preferences associated with one or more topics visited by a given user.

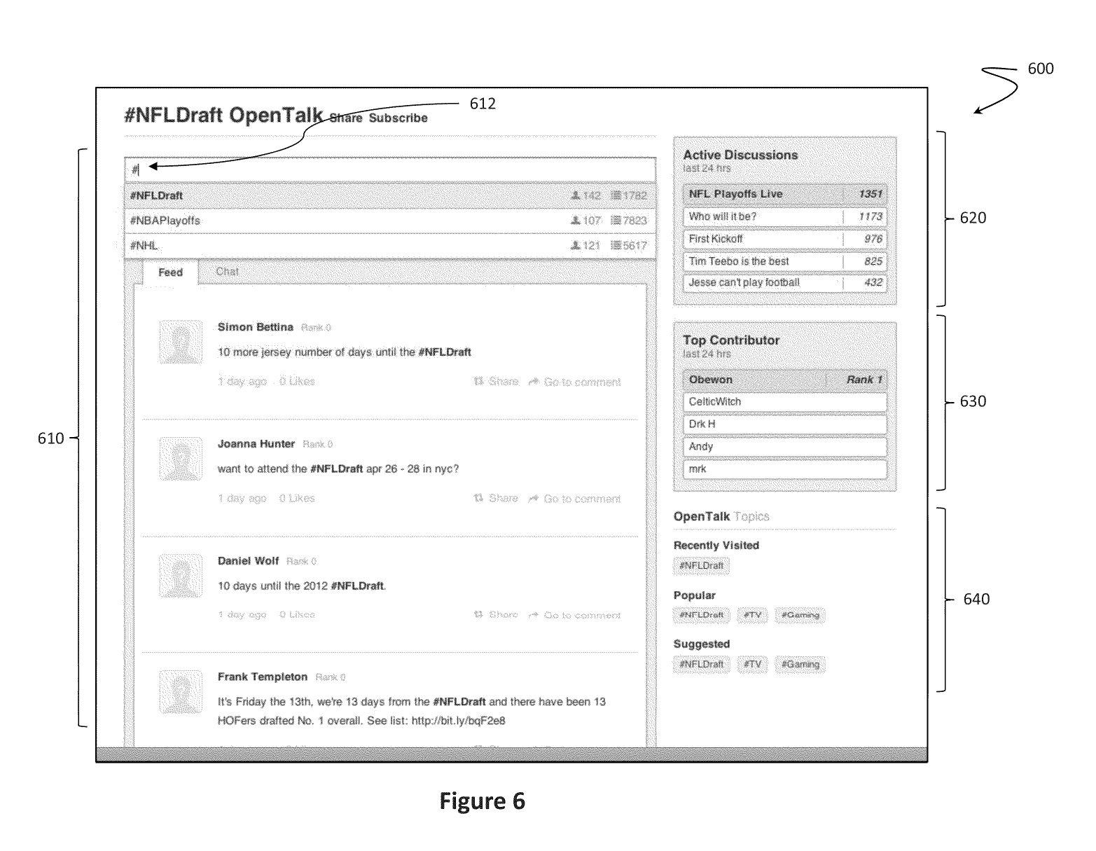

FIG. 6 illustrates yet another aspect of a landing page 600. As a user, or administrator, enters a topic indicator (e.g., the “#” sign), the system could present suggested topics 612 possibly based on auto complete, preferences, popularity, or other topic attribute. Each suggested topic could be displayed with information associated with that topic, such as the number of users who have posted using that topic name, or the number of comments made by users using that topic name. In a preferred embodiment, the list of suggested topics is sorted by popularity. Providing a list of suggestions in the user interface could also help a community naturally converge on a preferred topic name to prevent “scattering” when several users use different topic names that are synonymous with one another.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A conversation management system for a third party content provider comprising:
a server interface accessible to the third party content provider; and
a conversation server coupled with the server interface and configured to:
instantiate a conversation management platform associated with the third party content provider, the conversation management platform including management rules,
enable, via the conversation management platform, the third party content provider to present a conversation user interface according to the management rules, and
update, via the conversation management platform, the conversation user interface based on conversation content obtained at least in part via the conversation user interface.

2. The system of claim 1, wherein the server interface comprises at least one of the following: a software-as-a-service interface, an application program interface, a web service, and an HTTP server.

3. The system of claim 1, wherein the conversation content comprises multi-modal content.

4. The system of claim 1, wherein the conversation content comprises at least one of the following types of data: text data, audio data, kinesthetic data, video data, metadata, and image data.

5. The system of claim 1, wherein the conversation management platform is configured to indicate a topic via the conversation user interface based on the conversation content.

6. The system of claim 1, wherein the conversation management platform is configured to indicate a thread via the conversation user interface based on the conversation content.

7. The system of claim 1, wherein the conversation user interface is hosted by the third party content provider.

8. The system of claim 1, wherein the conversation server is further configured to instantiate the conversation management platform in response to a request submitted to the third party content provider.

9. The system of claim 1, wherein the conversation server is further configured to instantiate the conversation management platform in exchange for a fee.

10. The system of claim 9, wherein the fee comprises at least one of the following: a subscription, a per-use charge, a topic charge, an exclusivity charge, a bid, and an advertisement payment.

11. The system of claim 1, wherein at least some of the conversation content is obtained via a source other than the third party content provider.

12. The system of claim 1, wherein at least some of the conversation content comprises an advertisement.

13. The system of claim 1, wherein the conversation management platform is resident on the third party content provider.

14. The system of claim 1, wherein the conversation management platform is resident on the conversation server.

15. The system of claim 1, wherein the conversation management platform is resident on an intermediary server between the conversation server and the third party content provider.

16. The system of claim 1, wherein the conversation server is remote from the third party content provider.

17. The system of claim 1, wherein the conversation user interface comprises a social network interface.

18. The system of claim 1, wherein the conversation server is further configured to instantiate a plurality of conversation platforms, each associated with distinct third party content providers.

19. The system of claim 18, wherein the conversation server is further configured to construct an inter-platform communication channel among at least some of the plurality of conversation platforms through which the platforms can exchange the conversation content.

20. The system of claim 1, wherein the management rules comprise at least one of the following types of rules: authorization rules, authentication rules, filter rules, topic rules, thread rules, permission rules, user interface rules, curation rules, and metric aggregate rules.

21. The system of claim 1, wherein the management rules instruct the third party content provider to construct the conversation user interface on a mobile device.

22. The system of claim 21, wherein the mobile device comprises at least one of the following: a cell phone, a tablet, and an automobile.

23. The system of claim 21, wherein the conversation content includes content obtained from the mobile device.
